(19) United States
(12) Patent Application Publication
(10) Pub. No.: US 2012/0292309 A1
(43) Pub. Date: Nov. 22, 2012

(54) BRANDING APPARATUS AND METHOD

(76) Inventor: MATHIEU FONTAINE, DRUMMONDVILLE (CA)

(21) Appl. No.: 13/112,277

(22) Filed: May 20, 2011

(51) Int. Cl. H05B 6/02

(52) U.S. Cl. 219/618

(57) ABSTRACT

An apparatus and a method for heat-branding carcasses, comprising a induction heating unit and at least one branding stamp adapted to be heated by the induction heating unit in a heating position and to brand the carcasses in a branding position, the branding stamp is made in a heat conductive, electrically conductive, and mechanically resistant material.

### FIELD OF THE INVENTION

The present invention relates to branding. More specifically, the present invention is concerned with a apparatus and method for branding carcasses.

### BACKGROUND OF THE INVENTION

In the pork industry, branding of pork carcasses, i.e. the slaughtered animals typically after the edible organs and offal have been removed for example, also referred to in the field as the dressed carcasses, is required by food inspection authorities for example.

Ink stamps have been used to mark the carcasses. However, although edible, the ink applied on the carcasses may spill through the hide and contaminate the fat or the meat for example.

There is a need in the art for an apparatus and a method allowing cost-effectively branding carcasses without contamination, at high rates.

### SUMMARY OF THE INVENTION

More specifically, there is provided an apparatus for heat-branding carcasses, comprising a induction heating unit and at least one branding stamp adapted to be heated by the induction heating unit in a heating position and to brand the carcasses in a branding position.

There is further provided a method for heat-branding carcasses, comprising induction heating at least one branding stamp in a heating position; and branding the carcasses with the at least one heated branding stamp.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 is a overhead schematical view of a unit using a apparatus according to an embodiment of an aspect of the present invention;

FIG. 2 is a perspective view of a apparatus according to an embodiment of an aspect of the present invention;

FIG. 3 is a front view of a apparatus according to an embodiment of an aspect of the present invention;

FIGS. 4 are side views of a apparatus according to an embodiment of an aspect of the present invention, a) with the branding head in a heating position; b) with the branding head heated and ready for branding; and c) with the heated branding head in a branding position;

FIG. 5 is a detail of a branding head according to an embodiment of an aspect the present invention;

FIG. 6 is a detail of a branding head according to an embodiment of an aspect the present invention;

FIG. 7 is a detail of a branding head according to an embodiment of an aspect the present invention;

FIG. 8 is a detail of a branding head according to an embodiment of an aspect the present invention;

FIG. 9 is a detail of a branding head according to an embodiment of an aspect of the present invention;

FIGS. 10 show a sleeve for a branding head according to an embodiment of an aspect of the present invention: a) perspective view and b) cross sectional view;

FIGS. 11 show a sleeve for a branding head according to an embodiment of an aspect of the present invention: a) perspective view, b) exploded view and c) cross sectional view; and

FIGS. 12 show a sleeve for a branding head according to an embodiment of an aspect of the present invention, a) perspective view, b) exploded view and c) a cross sectional view.

### DESCRIPTION OF EMBODIMENTS OF THE INVENTION

The apparatus and method of the present invention will be described in relation to the branding of pork carcasses for illustrative purposes only and in a non-limitating way.

The illustrated apparatus is designed to brand carcasses, at shoulder level for example, with a certification seal, in synchronisation with a slaughter line. Other branding locations on the carcasses may be contemplated.

The apparatus generally comprises a heating unit and a branding head. A positioning unit is to optimise branding depending on the specific application.

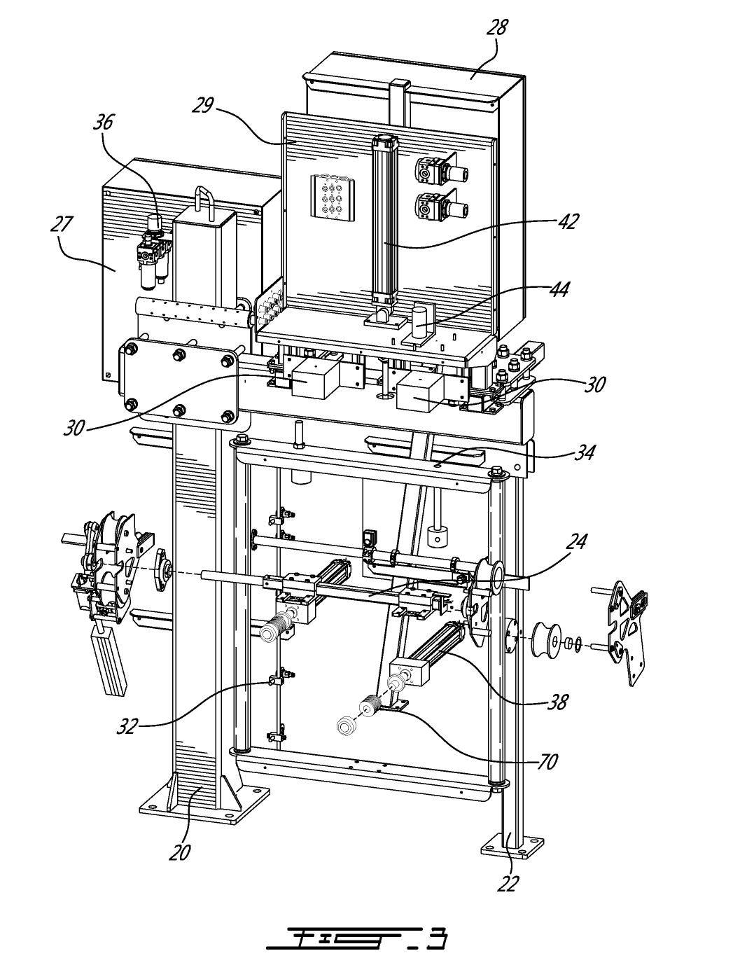

In an embodiment illustrated in FIGS. 2 to 4, the apparatus 10 comprises an adjustable frame 19 supporting a trolley 24 with guides 26, branding heads 18; an induction panel 28, a pneumatic panel 29; a control panel 27, and induction coils 30.

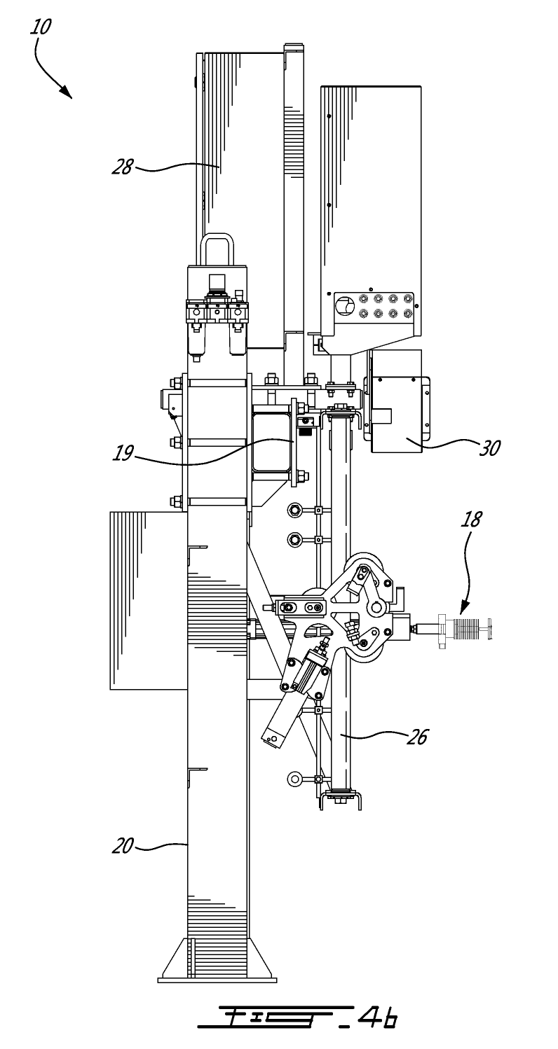

The frame 19 is anchored to the floor by feet 20 and 22, and typically supports all parts of the apparatus 10. A compressed air reservoir (not shown) may be located apart from the frame 19. This compressed air reservoir may be used for feeding the apparatus 10, with air at 100 psi for example, thereby allowing manual operation of the apparatus during a few cycles in the event of power failure or air leak in the central air system of the plant for example. The frame 19 may be adjustable for an optimized positioning relative to the localisation of the carcasses. The trolley 24 is positioned along a generally vertical direction by the guides 26, between the position of heating (see FIG. 4a) and the position of branding (see FIG. 4c) of the branding heads 18, as will be described hereinbelow.

Hot stamping may be achieved by using heating elements to heat branding stamps at a temperature typically between 400 and 650° C. However, it is found that the life time of the heating elements is difficult to predict and monitor, the temperatures are difficult to control, and the heating time is too high. Lasers may also be used, but their marking efficiency is limited by tight focal distance tolerances; moreover washability of laser equipments may be an issue.

The heating unit of the present invention uses induction heating, which proves to be clean, safe and easy to use and control, cost effective and fast.

The induction panel 28, of the resonant switched mode type for example, includes capacitors and electronic elements generating a variable power (5 to 100%), which is then transformed into a target frequency, selected depending on the material of the branding stamp, transferred to induction coils 30. The induction coils 30, connected to the induction panel 28, generate a magnetic field which heats the branding heads 18. Cold water is used to cool down the induction coils 30 and the electronic elements.

The control panel 27 monitors the induction power, branding temperature and height, movements of the branding head. The control panel 27 allows a manual starting of heating and branding cycles if needed.

The pneumatic panel 29 comprises pneumatic valves that control the strokes, and pressure relief and flow limiter devices that monitor the speed and force of the strokes.

A service unit 36 may be used to maintain operating conditions of the pneumatic systems of the apparatus 10, by monitoring the pressure of air from the compressed air reservoir and providing a regulated lubricant source.

As people in the art will appreciate, pneumatic driven movements may be replaced by electric driven movements using stepping electric motors for example.

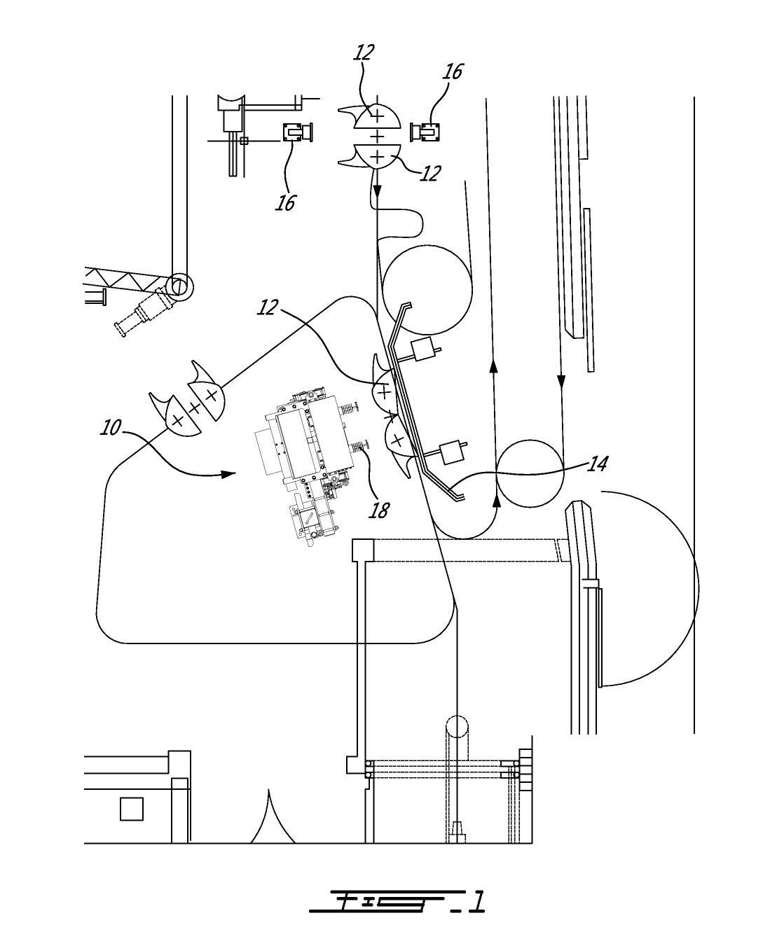

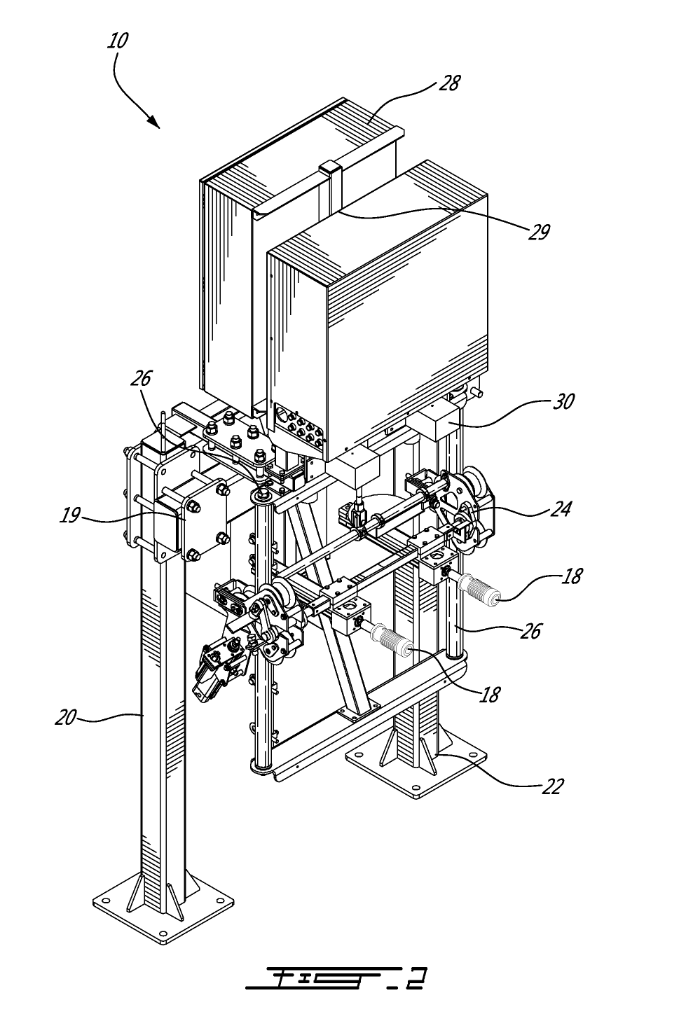

In the illustrated embodiments, the positioning unit comprises a first unit to determine the branding position on the carcasses (see for example reference 16 in FIG. 1), and a second unit, comprising detectors 32 discussed hereinbelow for example, for linear positioning of the branding heads for branding when the carcass is positioned in front of the branding apparatus at the adequate location.

In cases when branding is to be done at a location that does not vary from carcasses to carcasses or at a random location for example, the first unit may not required. In the present illustrated case where branding is to be achieved on the shoulder, the first unit measures the height of the carcasses so as to locate the shoulder level thereof, as will be described hereinbelow.

As shown in FIG. 1, carcasses 12 are conveyed before the apparatus 10, for example by rails 14. For each carcass 12 passing in front of the apparatus 10, as the height of the shoulders of the carcasses relative to the ground may vary, the branding head of the apparatus is positioned depending on measures sent by a sensor unit 16. The sensor unit 16 typically measures the height of each carcass 12, and sends the results to the apparatus 10, so that the apparatus 10 positions itself so as to brand the carcass at the level of the shoulders, whatever the size of the carcass, as will be described hereinbelow.

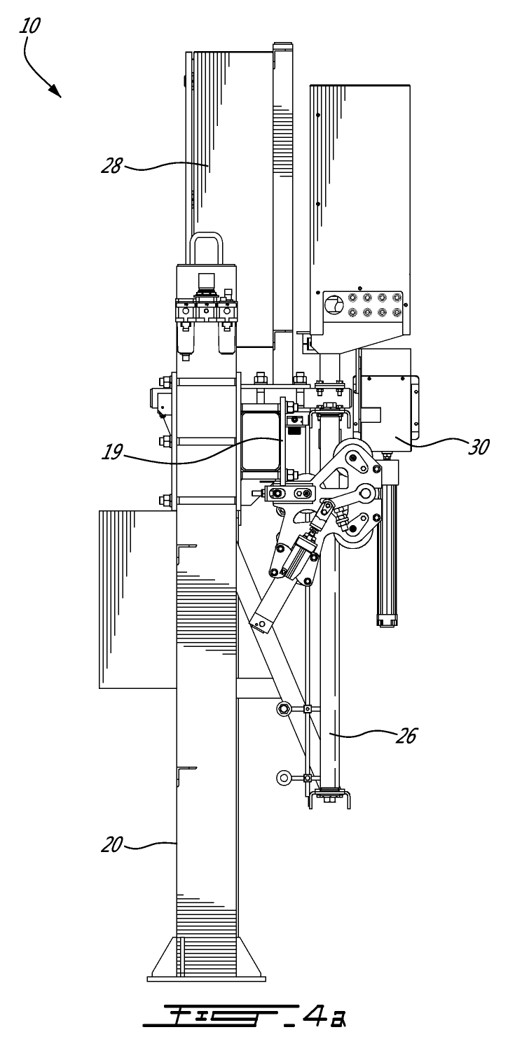

Proximity sensors 32 are used to monitor the position of the trolley 24, i.e. between a lower position, a middle position, which allows rotation of the branding rod 38, and a higher position, which activates heating of the branding heads 18 by the coils 30 in the heating position (see FIG. 3).

An ultrasonic detector 34 is used to detect the position of the trolley 24, i.e. its height relative to the ground, in relation with the sensor unit 16 that measures the carcasses as discussed hereinabove: the measurements taken by the sensor unit 16 are used by the detector 34 when the corresponding carcasses pass by the apparatus 10, to adjust the height of the trolley 24 for branding.

An infrared sensor 44 monitors the temperature of the branding stamp 50 as the branding stamp 50 is being heated by the coils 30 in the heating position. Induction heating may thus started when the temperature of the branding stamp 50 is below a predetermined threshold, for example below 600° C., or stopped when the temperature of the branding stamp 50 is too high, for example above 900° C. Such thresholds are predetermined depending on a number of parameters including the induction power, the material of the branding stamp and the branding rate.

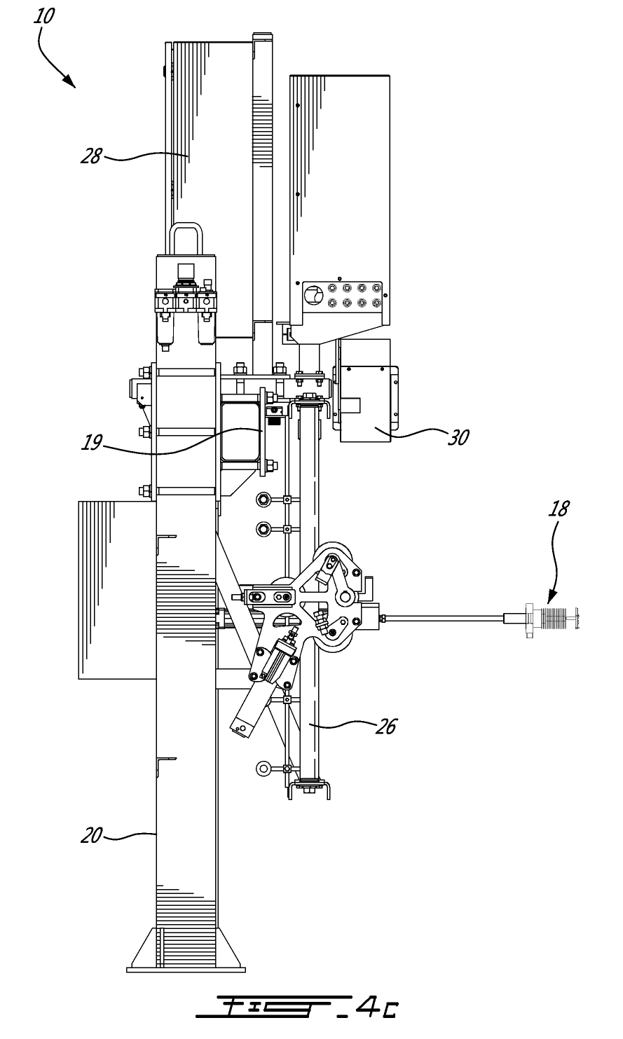

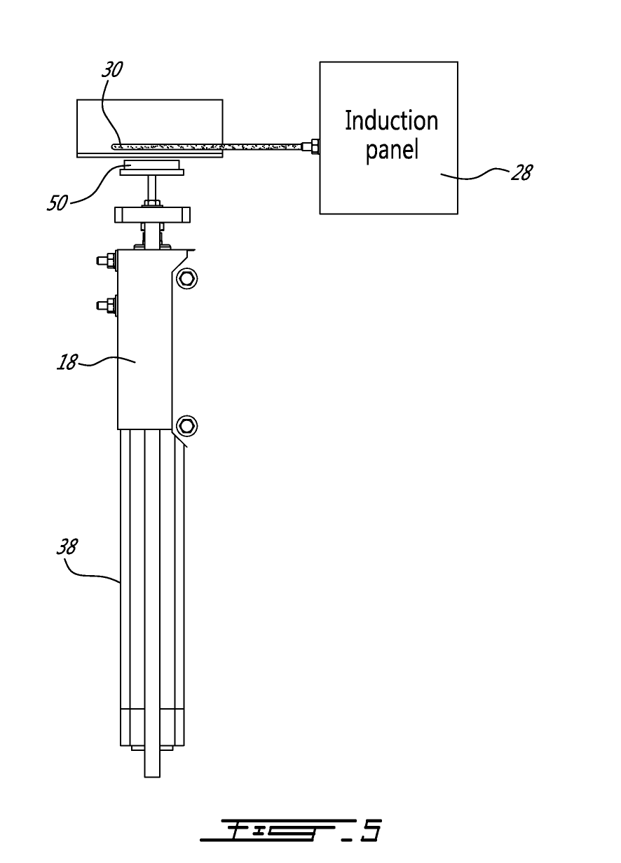

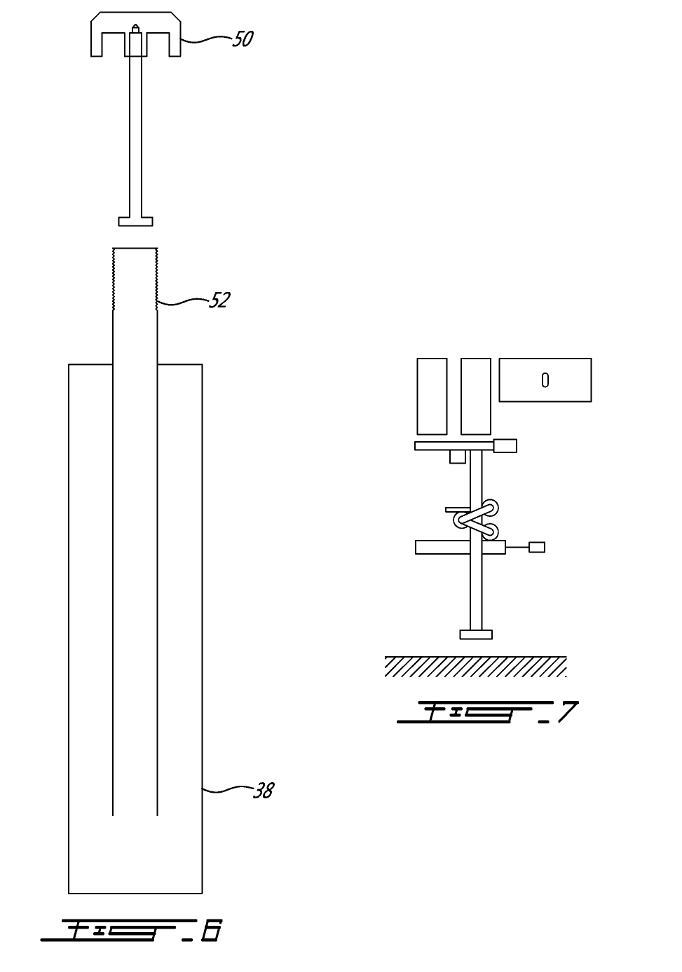

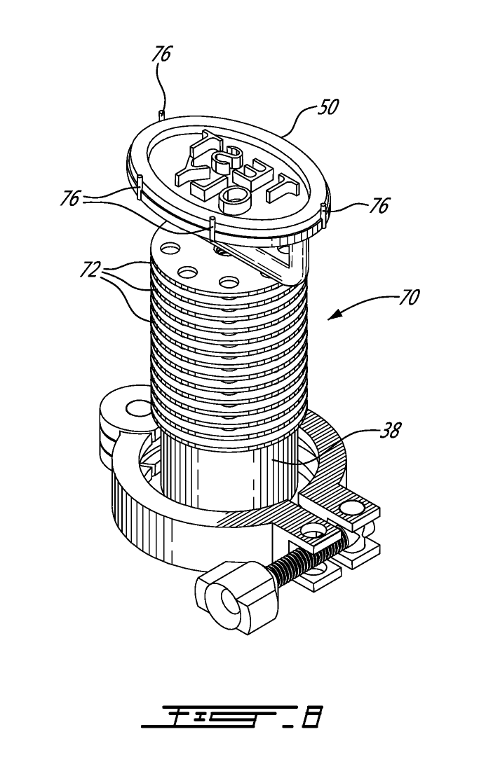

As illustrated in FIGS. 5 and 6, the branding head 18 is supported at the free end of a branding arm 52 connected to a branding rod 38 movable in a vertical position through action of a cylinder stroke 42 that controls the height of the branding position. The branding stamp 50 itself is secured at the extremity of the branding head 18. FIG. 4a is a side view of the apparatus 10 with the branding head 18 in a heating position, i.e. directed upwards in contact with the coils 30 in the illustrated embodiments. FIG. 4b is a side view of the apparatus 10 with the branding head 18 heated and ready for branding; and FIG. 4c is a side view of the apparatus 10 with the heated branding head 18 in a branding position, i.e. directed toward the carcass (not shown).

The shape and geometry of the branding stamp 50 may be optimised for an optimised heat transfer from the coils 30, thereby optimising the time needed for heating.

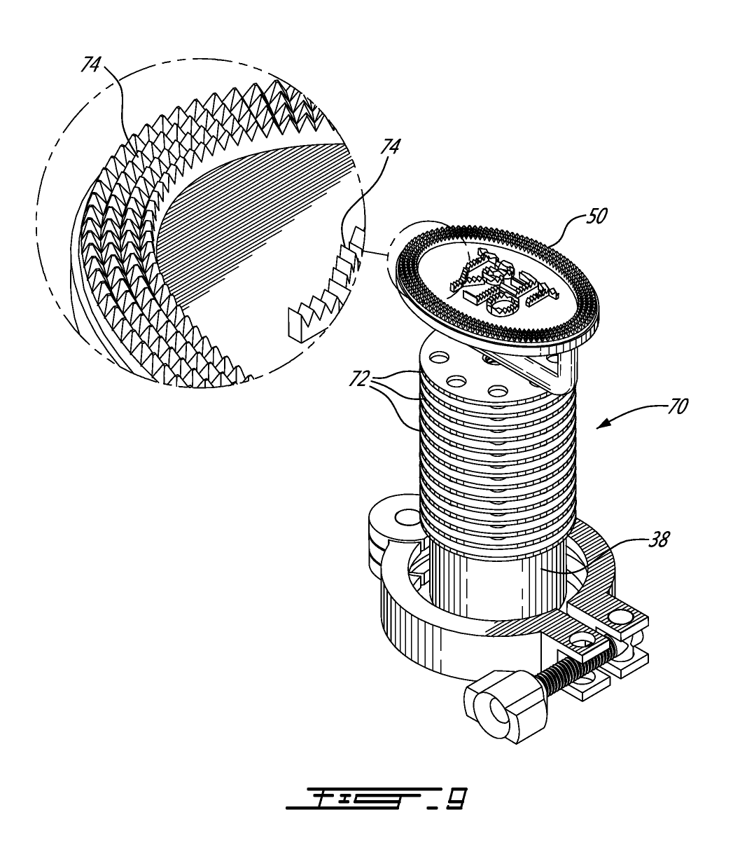

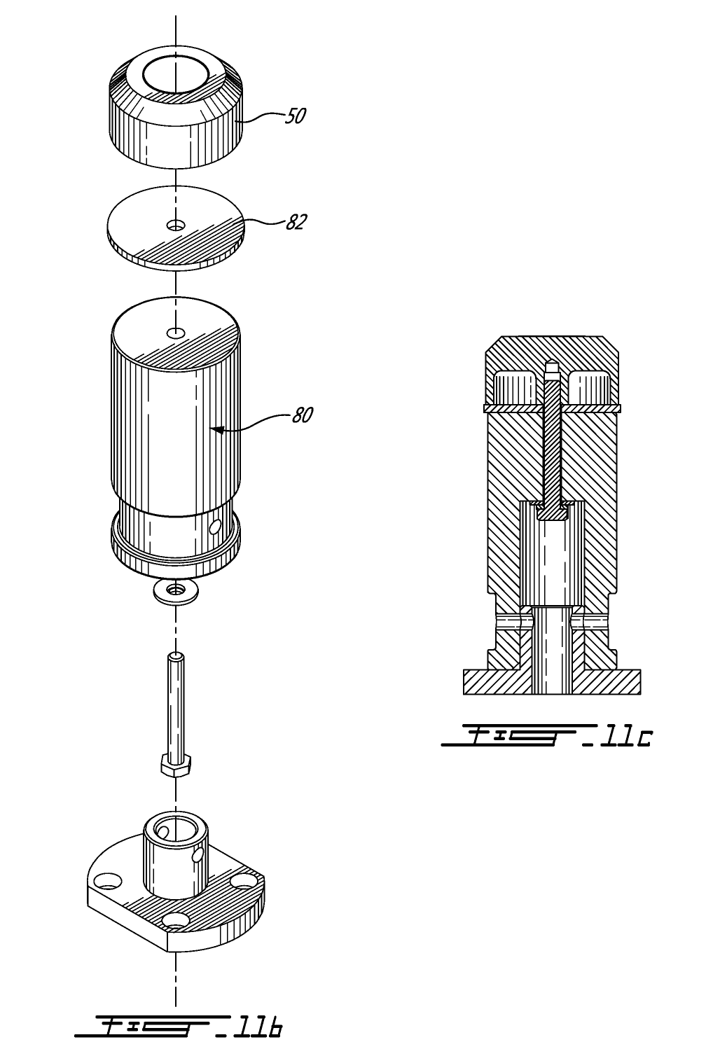

As the temperature of the branding stamp 50 may reach a high temperature, typically higher than 600° C. depending in particular on the branding rate and the induction power, the branding rod 38 generally needs to be thermally isolated from the branding stamp 50. A sleeve 70 comprising fins 72 and 72′ may be selected, in stainless steel for example, as illustrated for example in FIGS. 8 to 10. It is found that a short such sleeve 70 allows efficient passive heat dispersion between the branding stamp 50 and the branding rod 38, so that the temperature at the branding rod 38 is below 100° C., for example below 30° C. As shown for example in FIG. 10, the fins may have different thicknesses from the bottom of the sleeve 70 (fins 72′ for example) to the top of the sleeve 70 (see fins 72 for example).

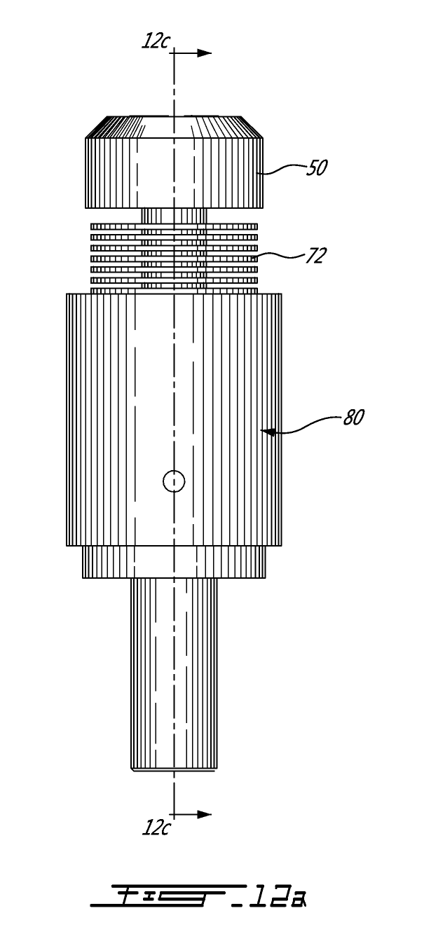

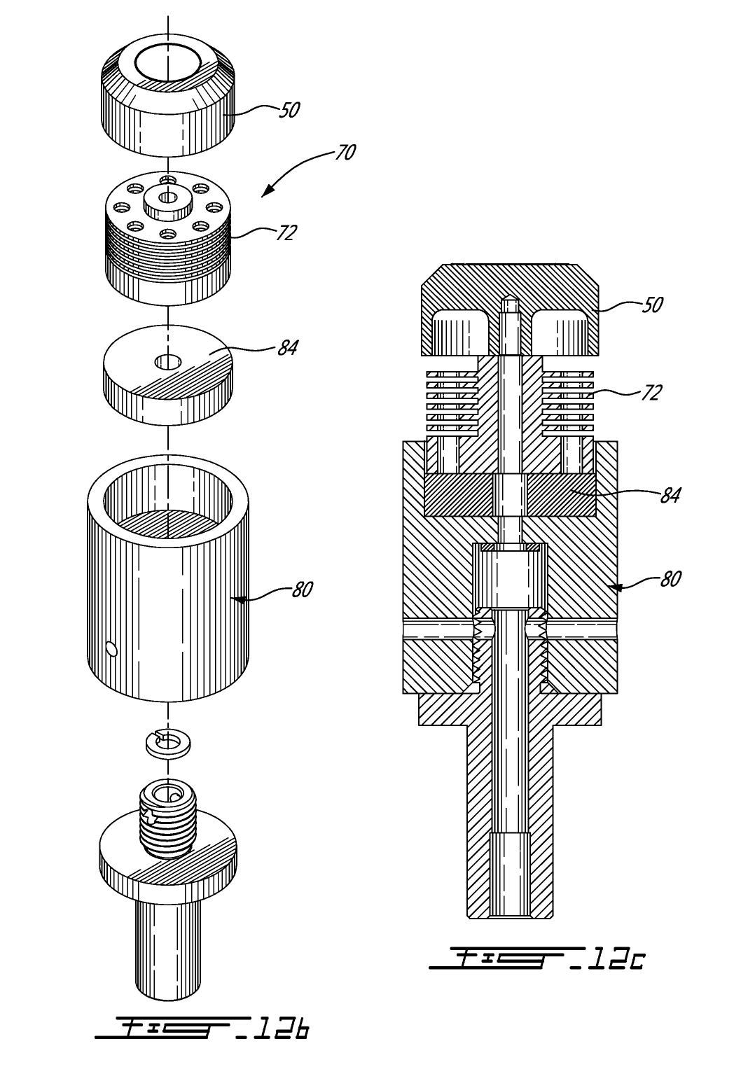

Alternatively, or in combination with a sleeve with heat dissipating fins, a refractory or insulating sleeve 80 may be provided between the branding rod 38 and the branding stamp 50, using a washer 82 for example as shown in FIG. 11. Such sleeve needs be in a material that is simultaneously machinable, resistant, non brittle and resistant to temperatures up to 1000° C. In FIG. 12, the refractory or insulating sleeve 80 is combined with an insulating felt 84 and a sleeve 70 comprising fins 72.

The branding stamp 50 may be in brass, in stainless steel, or in a heat conductive and electrically conductive material, provided it is mechanically resistant since the branding stamp 50 is typically submitted to impacts. Also, the material of the branding stamp 50 may be selected depending on the available induction power.

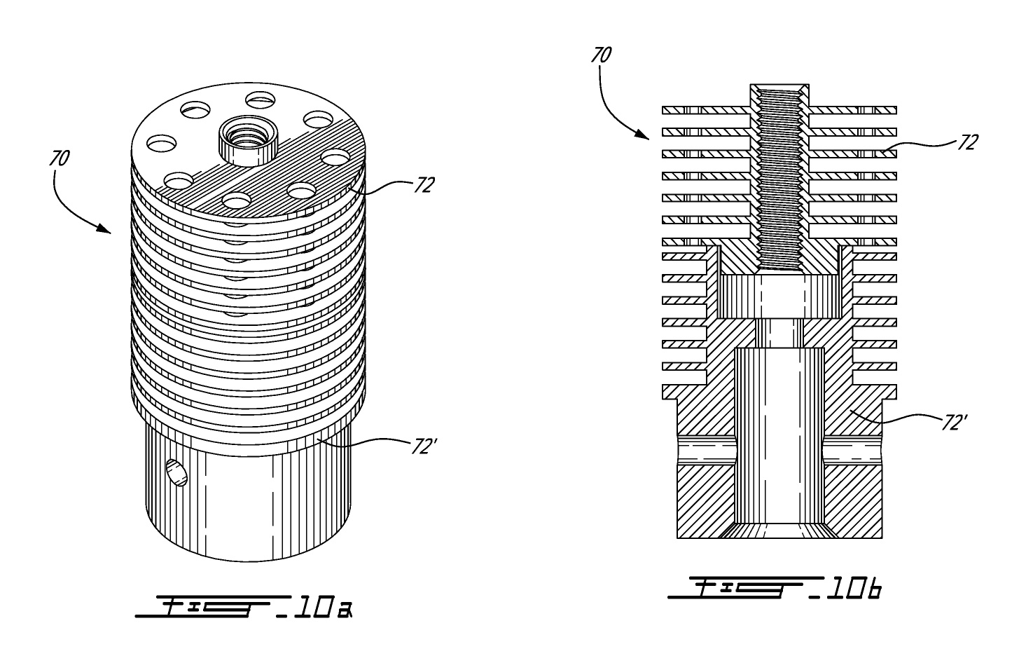

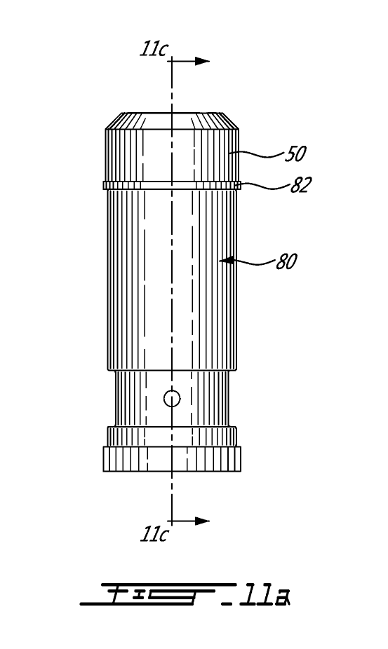

The carcasses pass by in front of the apparatus without pausing, at a rate of at least 600 carcasses per hour, at a rate of 675 carcasses per hour for example, and up to at least 1300 carcasses per hour for example. As a result, the marking achieved by the branding stamp 50 may be blurred due to the movement of the carcasses. For a more precise marking, the branding stamp 50 may be provided with knurling 74 on its surface, as illustrated for example in FIG. 9, or with teeth 76 welded on its periphery as illustrated for example in FIG. 8, which grip the carcass as the branding stamp 50 is applied thereon, thereby reducing slippage of the stamp over the carcass.

According to an embodiment of an aspect of the present invention, a sensor unit 16, located upstream of the apparatus, for example 15 foot upstream of the apparatus, detects the presence of an incoming carcass and determine its size as it passes by, and send the results to the apparatus. The apparatus uses this data for adjusting the vertical position of the branding arm. The branding arm, in a heating position as shown for example in FIGS. 4 and 6, is directed so that the branding stamp 50 is heated by induction by the electromagnetic coils 30. Then, the branding arm is pivoted to a generally horizontal direction and positioned along a generally vertical direction at a position determined by the data sent by the sensor unit 16 upstream of the apparatus, with the heated branding stamp directed toward the passing carcass. Once the heated branding stamp has been driven towards the carcass for marking, the branding arm is retracted backwards from the branding position, and returned to the heating position.

The present method and apparatus, using induction heating of the branding heads, allow a branding rate higher than 600 carcasses per hour, for example a rate of at least 675 carcasses per hour, and up to at least 1300 carcasses per hour for example providing adjustments to the mechanical elements of the apparatus 10 described hereinabove. Using more powerful pneumatic strokes, or using robotic arms instead of pneumatic strokes, and/or increasing the induction power may be contemplated for example. Moreover, the branding arm movements, as described hereinabove, may be simplified between the heating position and the branding position for example.

The present method and apparatus allow optimising the heating time, thereby allowing synchronisation with the high rates of the slaughter lines. The present apparatus uses a controlled and reliable source of heat for the branding heads, and can be easily adapted to different branding positions on carcasses, while being compact, mechanically and electrically simple and of easy maintenance.

Although the present invention has been described hereinabove by way of embodiments thereof, it may be modified, without departing from the nature and teachings of the subject invention as defined in the appended claims.

1. An apparatus for heat-branding carcasses, comprising a induction heating unit and at least one branding stamp adapted to be heated by said induction heating unit in a heating position and to brand the carcasses in a branding position.

2. The apparatus of claim 1, further comprising a positioning unit, said positioning unit monitoring said branding position of the at least one branding stamp.

3. The apparatus of claim 1, further comprising a positioning unit and a measuring unit, said measuring unit measuring a size of the carcasses and sending data to said positioning unit, said positioning unit using said data to adjust said branding position of the at least one branding stamp.

4. The apparatus of claim 1, wherein said induction heating unit generates a variable power transformed into a target frequency transferred to at least one induction coil, said at least one induction coil generating a magnetic field which heats the at least one branding stamp in said heating position.

5. The apparatus of claim 1, further comprising at least one temperature sensor, said at least one temperature sensor monitoring a temperature of said at least one branding stamp in said heating position.

6. The apparatus of claim 1, further comprising at least one sensor adapted to monitor a position of the at least one branding stamp between said heating position and said branding position.

7. The apparatus of claim 1, wherein said at least one branding stamp comprises at least one branding face and a support for said at least one branding face, said support being thermally shielded from said at least one branding face by a heat-dissipating sleeve.

8. The apparatus of claim 1, wherein said at least one branding stamp comprises at least one branding face and a support for said at least one branding face, said support being thermally shielded from said at least one branding face by a sleeve comprising heat-dissipating fins.

9. The apparatus of claim 1, wherein said at least one branding stamp comprises at least one branding face and a support for said at least one branding face, said support being thermally shielded from said at least one branding face by an insulating sleeve.

10. The apparatus of claim 1, wherein said at least one branding stamp is made in brass.

11. The apparatus of claim 1, wherein said at least one branding stamp is made in stainless steel.

12. The apparatus of claim 1, wherein said at least one branding stamp is made in a heat conductive, electrically conductive, and mechanically resistant material.

13. The apparatus of claim 1, wherein said at least one branding stamp comprises knurling on a branding surface thereof.

14. The apparatus of claim 1, wherein said at least one branding stamp comprises teeth on a periphery thereof.

15. The apparatus of claim 1, wherein said at least one branding stamp heated by said induction heating unit brands carcasses at a rate of at least 600 carcasses per hour.

16. A method for heat-branding carcasses, comprising induction heating at least one branding stamp in a heating position; and branding the carcasses with the at least one heated branding stamp.

17. The method of claim 16, further comprising positioning the at least one branding stamp, once heated, from said heating position to a branding position.

18. The method of claim 16, further comprising determining a branding position, and positioning the at least one branding stamp, once heated, from said heating position to said branding position.

19. The method of claim 16, comprising branding carcasses with the at least one heated branding stamp at a rate of at least 600 carcasses per hour.
